(19) United States
(12) Patent Application Publication
(10) Pub. No.: US 2011/0168800 A1
(43) Pub. Date: Jul. 14, 2011

(54) FLOW CONTROL FOR SPREADER

(76) Inventor: Marty Warchola, Medina, OH (US)

(21) Appl. No.: 12/823,294

(22) Filed: Jun. 25, 2010

Related U.S. Application Data
(60) Provisional application No. 61/221,212, filed on Jun. 29, 2009.

(51) Int. Cl. E01H 10/00; A01C 17/00; C09K 3/18

(52) U.S. Cl. 239/7; 239/665; 239/668; 239/675; 239/676

(57) ABSTRACT

A spreader assembly may include a hopper, a spinner plate and an aperture adjustment mechanism. The aperture adjustment mechanism may include a gate supported to the frame and defining an aperture through which material travels on its way to the spinner plate; and, a motor suitable to adjust the size of the aperture and thereby to control the flow of the material onto the spinner plate.

This application claims priority to U.S. Ser. No. 61/221,212, entitled FLOW CONTROL FOR SPREADER, filed Jun. 29, 2009, which is incorporated herein by reference.

### I. BACKGROUND

A. Field of Invention

This invention pertains to the art of spreader assemblies used to spread materials such as salt and sand onto road surfaces, and more specifically to methods and apparatuses for controlling the amount of material spread and the speed at which it is spread.

B. Description of the Related Art

Salt and/or sand spreading is a common practice to maintain roads, parking spaces, and other ground surfaces during the winter months. It is known to use larger vehicles as well as smaller vehicles, such as pickup trucks, to perform this type of service. Numerous types of spreader assemblies have been developed to be attached to conventional vehicles. Typically, the spreader assembly is attached to the rear of the vehicle to spread particulate material, such as salt, sand, cinders, etc. onto the ground surface being traveled by the vehicle. One of the more common spreader assemblies employs a hopper having a lower discharge opening through which the particulate material falls onto a rotating spinner plate. By rotating the spinner plate as material is being discharged onto the spinner plate, the particulate material is centrifugally propelled by the spinner plate in a wide pattern onto the ground surface. Typically, a motor is mounted on the spreader assembly to cause the spinner plate to rotate. Some spreader assemblies also include an auger mechanism which helps to transfer the material from the hopper to the spinner plate.

While many known spreader assemblies work well for their intended purpose, improvements are desirable. It would be beneficial to provide a spreader assembly that can better control the amount of material spread and the speed at which it is spread.

### II. SUMMARY

According to one embodiment of this invention, a spreader assembly may comprise: a frame that is attachable to an associated vehicle; a hopper supported to the frame and suitable to hold material that is suitable to be spread onto an associated ground surface; a spinner mechanism supported to the frame and comprising a spinner plate that is suitable to spread the material onto the associated ground surface; and, an aperture adjustment mechanism comprising: a first gate supported to the frame and defining a first aperture through which the material travels on its way to the spinner plate; and, a first motor suitable to adjust the size of the first aperture and thereby to control the flow of the material onto the spinner plate.

According to another embodiment of this invention, a spreader assembly may comprise: a frame that is attachable to an associated vehicle; a hopper supported to the frame and suitable to hold salt to be spread onto an associated ground surface; a spinner mechanism supported to the frame and comprising a spinner plate that is suitable to spread the salt onto the associated ground surface; an auger mechanism comprising an generally vertically oriented auger that helps to transfer the salt from the hopper to the spinner plate; and, an aperture adjustment mechanism comprising: a first gate supported to the frame, positioned downstream of the auger, and defining a first aperture having a circular cross-section through which the salt travels on its way to the spinner plate; a first motor suitable to adjust the size of the first aperture and thereby to control the flow of the salt onto the spinner plate; and, wherein the aperture adjustment mechanism adjusts the size of the aperture in a manner similar to a camera lens aperture adjustment.

According to yet another embodiment of this invention, a method may comprise the steps of: (A) providing a spreader assembly comprising: (1) a frame; (2) a hopper supported to the frame and suitable to hold a material that is suitable to be spread onto an associated ground surface; (3) a spinner mechanism supported to the frame and comprising a spinner plate; and, (4) an aperture adjustment mechanism comprising: (a) a gate supported to the frame and defining a aperture; and, (b) a motor; (B) attaching the frame to a vehicle; (C) using the motor to adjust the size of the aperture; (D) moving the material from the hopper, through the aperture and onto the spinner plate; and, (E) operating the spinner plate to spread the material onto an associated ground surface.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a back view of a spreader assembly according to one embodiment of this invention shown attached to the back portion of a vehicle.

FIG. 2 is a schematic representation of a spreader assembly.

FIG. 3 is a cross-sectional view of an aperture adjustment mechanism.

### IV. DETAILED DESCRIPTION OF THE INVENTION

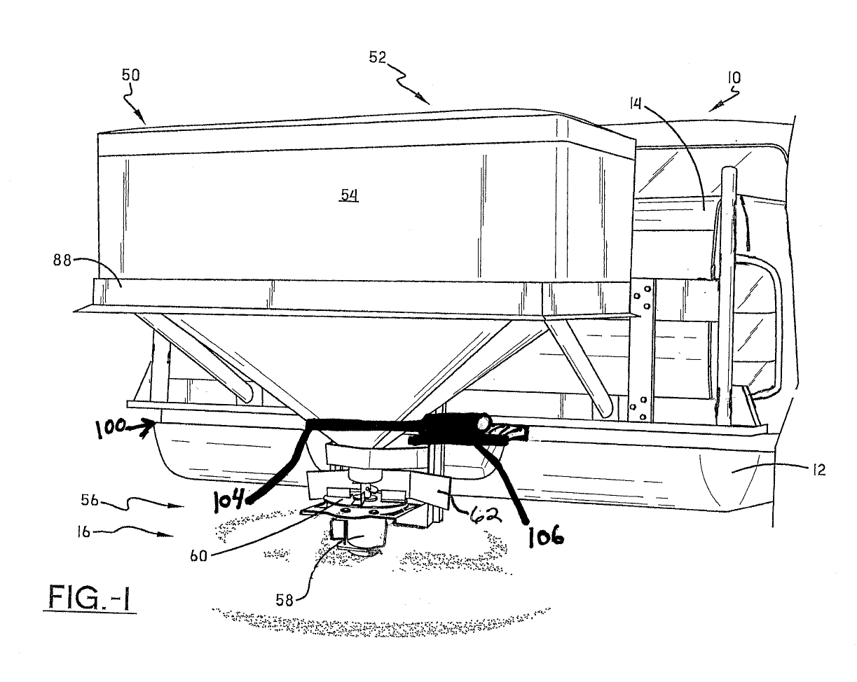

Referring now to the drawings wherein the showings are for purposes of illustrating embodiments of the invention only and not for purposes of limiting the same, FIG. 1 shows a spreader assembly 50 including an aperture adjustment mechanism 100 according to one embodiment of this invention, attached to back end of a vehicle 10. While the vehicle 10 shown is commonly known as a pick-up truck it should be noted that this invention will work with any vehicle chosen with the sound judgment of a person of skill in the art. The vehicle 10 may include a bumper 12, a tailgate 14 and a hitch (not visible but well known to those of skill in the art). Because the spreader assembly 50 is attached to back end of a pick-up truck having a tailgate 14, it is commonly referred to as a tailgate spreader. However, it should be noted that this invention will work with any spreader assembly chosen with the sound judgment of a person of skill in the art.

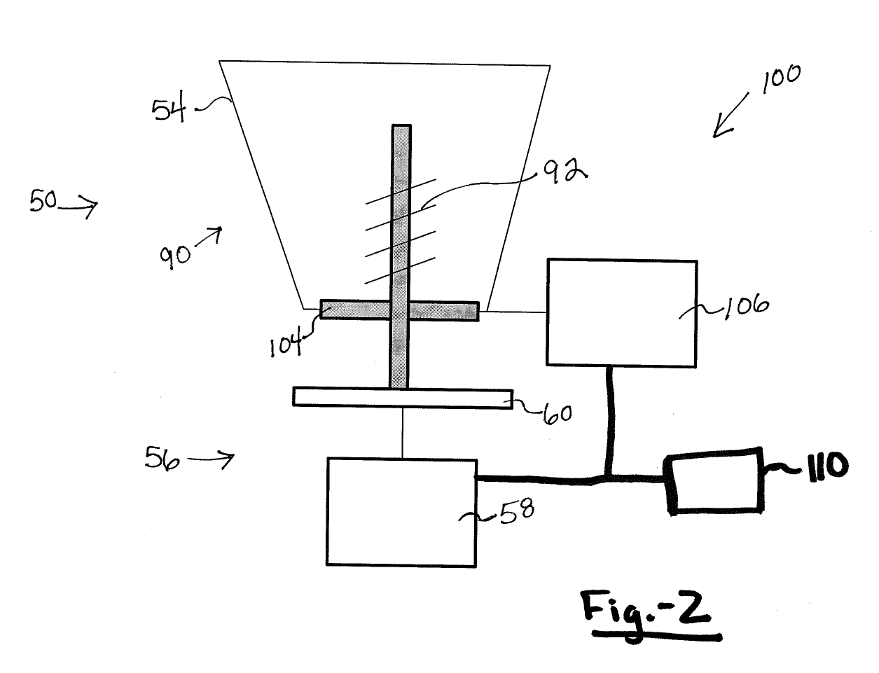

With reference now to FIGS. 1-2, the spreader assembly 50 may include a frame 52 that is attachable to the vehicle 10, a hopper 54 supported to the frame 52 for use in holding a material to be spread, and a spinner mechanism 56 supported to the frame 52 that is used to spread the material held in the hopper 54 onto any appropriate ground surface 16 including roads, parking spaces, drive ways, sidewalks, and the like. The frame 52 may include a hopper support member 88 to assist in supporting the hopper 54. The material held in the hopper 54 which is to be spread onto the ground surface 16 can be any appropriate for winter weather or other conditions chosen with the sound judgment of a person of skill in the art. Some non-limiting examples include salt, sand, and cinders. The hopper 54 can be of any design and formed of any material chosen with the sound judgment of a person of skill in the art. In one specific embodiment, the hopper 54 is formed of polyethylene and the material held within the hopper 54 is salt. The spinner mechanism 56 can be of any design chosen with the sound judgment of a person of skill in the art. For the embodiment shown, the spinner mechanism 56 includes a motor 58 and a spinner plate 60 that is rotatable by the motor 58 to spread the material held in the hopper 54 onto the ground surface 16. A baffle plate 62 may be used to prevent the material from being propelled toward the vehicle 10.

With continuing reference to FIGS. 1-2, as the general operation of a spreader assembly 50, including a spinner mechanism 56, is well known to those of skill in the art, details will not be described here. However, it should be noted that in one embodiment, shown, the spreader assembly 50 may also include an auger mechanism 90 which helps to transfer the material from the hopper 54 to the spinner plate 60. While the auger mechanism 90 may be of any type chosen with the sound judgment of a person of skill in the art, including the use of a generally horizontally oriented auger, for the embodiment shown, the auger mechanism 90 includes an auger 92 that is generally vertically oriented and extends through a discharge opening formed in the lower portion of the hopper 54. The auger 92 may be rotated, or otherwise driven, in one embodiment by the same motor 58 used to rotate the spinner plate 60. In another embodiment, the auger 92 may be rotated, or otherwise driven, by its own motor (not shown). It should be noted that an auger mechanism 90 is not required for this invention.

With reference now to FIGS. 1-3, the spreader assembly 50 may also include an aperture adjustment mechanism 100 used to adjust the size of an aperture 102 through which the material being spread travels on its way to the spinner plate 60. The aperture adjustment mechanism 100 can thus be used as a flow control mechanism that, alone or in combination with other components, controls the amount of material spread and/or the speed at which it is spread. The aperture 102 may be defined in a gate 104 that can be positioned at any location chosen with the sound judgment of a person of skill in the art. In one embodiment, shown, the gate 104 is positioned within in the body of the hopper 54. In another embodiment, the gate 104 is formed in another structure positioned below the hopper 54. In cases where an auger mechanism 90 is used, the gate 104 may be positioned upstream of the auger 92, around the auger 92, or downstream of the auger 92. It is also contemplated to use multiple gates to adjust the size of multiple apertures.

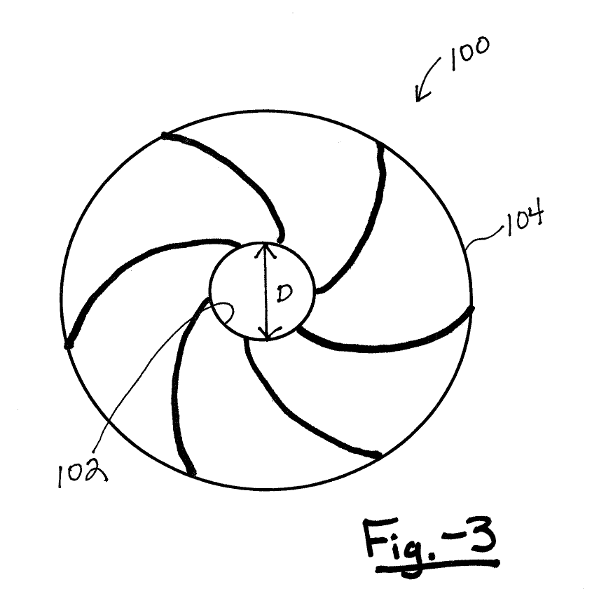

With continuing reference to FIGS. 1-3, the aperture adjustment mechanism 100 may adjust the size of the aperture 102 formed in the gate 104 in any manner chosen with the sound judgment of a person of skill in the art. In one embodiment, shown, the aperture adjustment mechanism 100 adjusts the size of the aperture 102 in a manner similar to a camera lens aperture adjustment. FIG. 3 shows the aperture 102 with a diameter D that can be adjusted to be larger or smaller by motor 106, shown in FIG. 2. While the aperture 102 shown has a circular cross-section, it should be understood that the aperture 102 may have any size or shape chosen with the sound judgment of a person of skill in the art. A controller 110 may be used to control the size of the aperture 102. The controller, in one embodiment, may be used to control the aperture adjustment mechanism 100, the spinner mechanism 56, and the auger mechanism 90 providing complete flow control for the operator.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A spreader assembly comprising:
a frame that is attachable to an associated vehicle;
a hopper supported to the frame and suitable to hold material that is suitable to be spread onto an associated ground surface;
a spinner mechanism supported to the frame and comprising a spinner plate that is suitable to spread the material onto the associated ground surface; and,
an aperture adjustment mechanism comprising:
a first gate supported to the frame and defining a first aperture through which the material travels on its way to the spinner plate; and,
a first motor suitable to adjust the size of the first aperture and thereby to control the flow of the material onto the spinner plate.

2. The spreader assembly of claim 1 wherein the first gate is positioned within the body of the hopper.

3. The spreader assembly of claim 1 wherein the first gate is positioned below the hopper.

4. The spreader assembly of claim 1 wherein the aperture adjustment mechanism further comprises:
a second gate supported to the frame and defining a second aperture through which the material travels on its way to the spinner plate; and,
wherein the first motor is suitable to adjust the size of the first aperture and thereby to control the flow of the material onto the spinner plate.

5. The spreader assembly of claim 1 wherein the aperture adjustment mechanism further comprises:
a second gate supported to the frame and defining a second aperture through which the material travels on its way to the spinner plate; and,
a second motor suitable to adjust the size of the second aperture and thereby to control the flow of the material onto the spinner plate.

6. The spreader assembly of claim 1 further comprising:
an auger mechanism comprising an auger that helps to transfer the material from the hopper to the spinner plate;
wherein the auger is driven by the first motor; and,
wherein the gate is positioned upstream of the auger.

7. The spreader assembly of claim 1 further comprising:
an auger mechanism comprising an auger that helps to transfer the material from the hopper to the spinner plate;
wherein the auger is driven by the first motor; and,
wherein the gate is positioned around the auger.

8. The spreader assembly of claim 1 further comprising:
an auger mechanism comprising an auger that helps to transfer the material from the hopper to the spinner plate;
wherein the auger is driven by the first motor; and,
wherein the gate is positioned downstream of the auger.

9. The spreader assembly of claim 1 wherein:
the aperture has a circular cross-section; and,
the aperture adjustment mechanism adjusts the size of the aperture in a manner similar to a camera lens aperture adjustment.

10. The spreader assembly of claim 1 further comprising:
a controller that controls the aperture adjustment mechanism and the spinner mechanism.

11. A spreader assembly comprising:
a frame that is attachable to an associated vehicle;
a hopper supported to the frame and suitable to hold salt to be spread onto an associated ground surface;
a spinner mechanism supported to the frame and comprising a spinner plate that is suitable to spread the salt onto the associated ground surface;
an auger mechanism comprising an generally vertically oriented auger that helps to transfer the salt from the hopper to the spinner plate; and,
an aperture adjustment mechanism comprising:
a first gate supported to the frame, positioned downstream of the auger, and defining a first aperture having a circular cross-section through which the salt travels on its way to the spinner plate;
a first motor suitable to adjust the size of the first aperture and thereby to control the flow of the salt onto the spinner plate; and,
wherein the aperture adjustment mechanism adjusts the size of the aperture in a manner similar to a camera lens aperture adjustment.

12. The spreader assembly of claim 11 wherein the first gate is positioned within the body of the hopper.

13. The spreader assembly of claim 11 wherein the first gate is positioned below the hopper.

14. The spreader assembly of claim 11 wherein the aperture adjustment mechanism further comprises:
a second gate supported to the frame and defining a second aperture through which the salt travels on its way to the spinner plate; and,
wherein the first motor is suitable to adjust the size of the first aperture and thereby to control the flow of the salt onto the spinner plate.

15. The spreader assembly of claim 11 wherein the aperture adjustment mechanism further comprises:
a second gate supported to the frame and defining a second aperture through which the salt travels on its way to the spinner plate; and,
a second motor suitable to adjust the size of the second aperture and thereby to control the flow of the salt onto the spinner plate.

16. The spreader assembly of claim 11 further comprising:
a controller that controls the aperture adjustment mechanism, the spinner mechanism, and the auger mechanism.

17. A method comprising the steps of:
(A) providing a spreader assembly comprising: (1) a frame; (2) a hopper supported to the frame and suitable to hold a material that is suitable to be spread onto an associated ground surface; (3) a spinner mechanism supported to the frame and comprising a spinner plate; and, (4) an aperture adjustment mechanism comprising: (a) a gate supported to the frame and defining a aperture; and, (b) a motor;
(B) attaching the frame to a vehicle;
(C) using the motor to adjust the size of the aperture;
(D) moving the material from the hopper, through the aperture and onto the spinner plate; and,
(E) operating the spinner plate to spread the material onto an associated ground surface.

18. The method of claim 11 wherein:
step (A) comprises the step of: providing the spreader assembly with an auger mechanism comprising an auger; and,
step (D) comprises the step of: operating the auger using the motor.

19. The method of claim 18 wherein:
step (A) comprises the step of: providing the spreader assembly with a controller; and,
step (C) comprises the step of: using the controller to adjust the size of the aperture; and,
step (D) comprises the step of: using the controller to control the movement of the material from the hopper, through the aperture, and onto the spinner plate.

20. The method of claim 19 wherein step (A) comprises the steps of:
providing the auger to be generally vertically oriented; and,
providing the gate to be positioned downstream of the auger.
